(19) United States
(12) Patent Application Publication
(10) Pub. No.: US 2013/0282329 A1
(43) Pub. Date: Oct. 24, 2013

(54) COMPUTING DEVICE AND METHOD OF COMPENSATING PRECISION OF MEASUREMENTS USING PROBES OF THREE-DIMENSIONAL MEASUREMENT MACHINES

(71) Applicants: HONG FU JIN PRECISION INDUSTRY (ShenZhen) CO., LTD., (US); HON HAI PRECISION INDUSTRY CO., LTD., New Taipei (TW)

(72) Inventors: CHIH-KUANG CHANG, New Taipei (TW); XIN-YUAN WU, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/862,615

(22) Filed: Apr. 15, 2013

(30) Foreign Application Priority Data
Apr. 23, 2012 (CN) 201210119719.8

(51) Int. Cl. G01B 21/02

(52) U.S. Cl. CPC G01B 21/02
USPC 702/152

(57) ABSTRACT

In compensating precision of measurements using a probe of a measurement machine, a physical ball is provided. Surface of the physical ball is divided into horizontal slices. Points are selected on the slices, and coordinates and vectors of the points are computed. A rotating vector N3 is computed by cross-multiplying a vector N1 of a pole of the probe and a vector N2 of the physical ball, and a rotating matrix is generated by rotating the physical ball around the rotating vector N3. The coordinates in the reference point set are updated by multiplying the coordinates with the rotating matrix. A measuring program is generated according to the reference point set. The measurement machine measures points on the physical ball twice using the measuring program, to generate measuring point sets Refs and Meas. Compensation values for the probe are computed using the measuring point sets Refs and Meas.

### BACKGROUND

1. Technical Field

Embodiments of the present disclosure relate to three-dimensional (3D) measurement systems and methods, and more particularly to a computing device and method of compensating precision of measurements using a probe of a three-dimensional (3D) measurement machine.

2. Description of Related Art

A three-dimensional (3D) measurement machine is a device for measuring physical geometrical characteristics of an object. The 3D measurement machine may be manually controlled by an operator. Measurements are taken by a probe attached to a moving axis of the 3D measurement machine. Probes may be mechanical, optical, laser, or white light, amongst other types.

The probe in a 3D measurement machine may suffer wear during measurements of objects, thus, measurement accuracy of the measurement machine may be reduced over time.

### BRIEF DESCRIPTION OF THE DRAWINGS

FIG. 1 is a block diagram of one embodiment of a computing device including a compensating system.

FIG. 2 is a block diagram of one embodiment of function modules of the compensating system in FIG. 1.

FIG. 3 illustrates a flowchart of one embodiment of a method of compensating precision of measurements using a probe of a 3D measurement machine.

FIG. 4 is an example of dividing a physical ball into a plurality of slices.

FIG. 5 is an example of computing coordinates of points in the slices of FIG. 4.

FIG. 6 illustrates how to compute a rotating vector N3.

FIG. 7 and FIG. 8 illustrate a connection point of a physical ball and a supporting pole.

### DETAILED DESCRIPTION

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable storage medium or other storage device. Some non-limiting examples of non-transitory computer-readable storage medium include CDs, DVDs, BLU-RAY, flash memory, and hard disk drives.

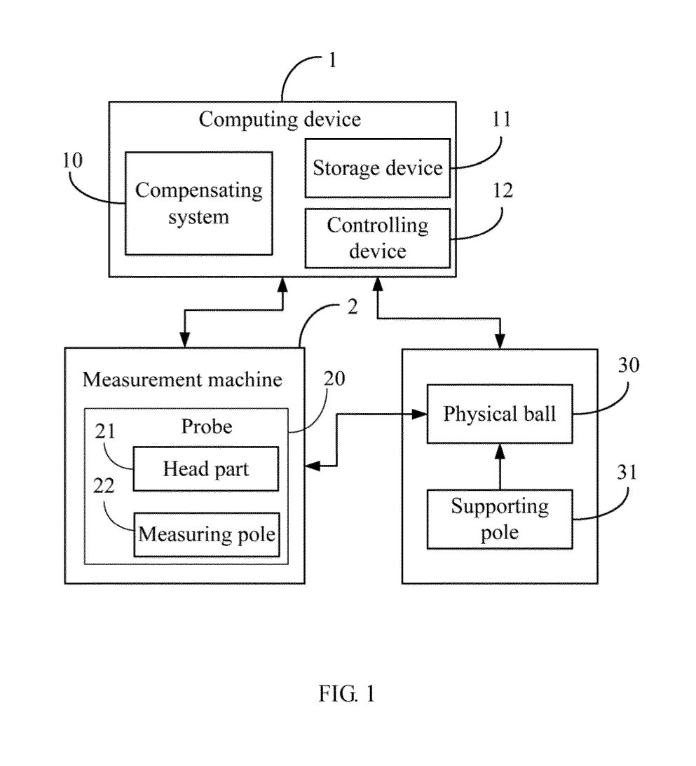

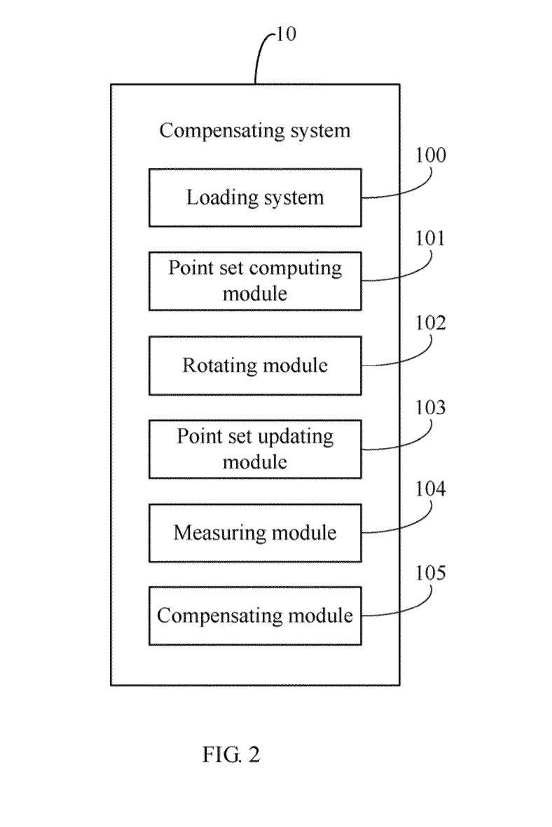

FIG. 1 is a block diagram of one embodiment of a computing device 1 including a compensating system 10. The computing device 1 may be, for example, a computer, a server, and so on. The compensating system 10 includes a plurality of function modules (see FIG. 2 and below), which include computerized codes stored in a storage device 11 of the computing device, when executed by a controlling device 12 of the computing device 1, to provide a method of calculating and applying compensations to a probe 20 of a 3D measurement machine 2 that is connected to the computing device 1, using a physical ball 30. The probe 20 includes at least a head part 21 and a measuring pole 22. The physical ball 30 rests on a supporting pole 31.

The storage device 11 may include any type(s) of non-transitory computer-readable storage medium, such as a hard disk drive, a compact disc, a digital video disc, or a tape drive. The storage device 11 stores data needed by the compensating system 10. The controlling device 12 may be a processor, a microprocessor, an application-specific integrated circuit (ASIC), and a field programmable gate array (FPGA), for example.

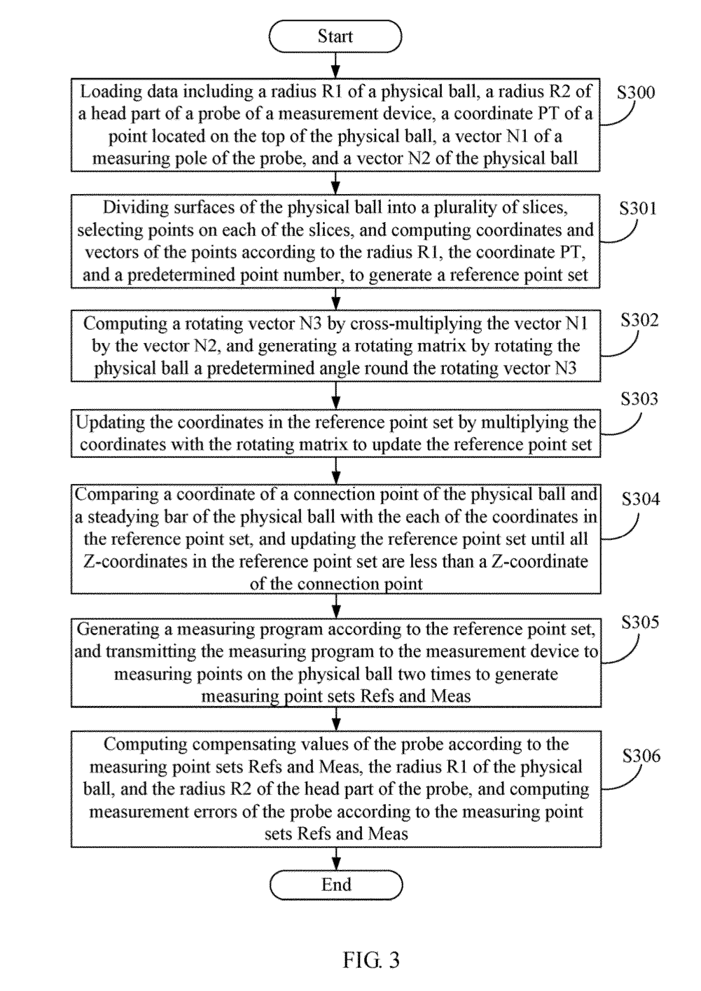

FIG. 2 is a block diagram of one embodiment of the function modules of the compensating system 10. In one embodiment, the function modules may include loading module 100, a point set computing module 101, a rotating module 102, a point set updating module 103, a measuring module 104, and a compensating module 105. The functions of the function modules 100-105 are illustrated in FIG. 3 and described below.

FIG. 3 illustrates a flowchart of one embodiment of a method of compensating precision of measurements using a probe of a 3D measurement machine. Depending on the embodiment, additional steps may be added, others removed, and the ordering of the steps may be changed.

In step S300, the loading module 100 loads data from the storage device 11, where the data includes a radius R1 of the physical ball 30, a radius R2 of the head part 21 of the probe 20, a coordinate PT of a point located on the top of the physical ball 30, a vector N1 of the measuring pole 22 of the probe 20, and a vector N2 of the physical ball 30.

In step S301, the point set computing module 101 divides surface of the physical ball 30 into a plurality of horizontal slices according to a predetermined angle, selects points on each of the slices according to a predetermined point number, and computes coordinates and vectors of the points according to the radius R1, the coordinate PT, and the vector N2 of the physical ball 30, to generate a reference point set.

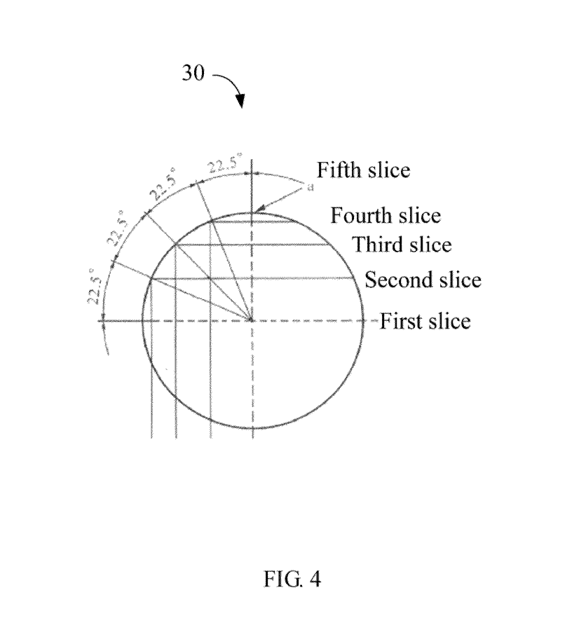

In one embodiment, referring to FIG. 4, the point set computing module 101 divides an upper part of the surface of the physical ball 30 into five slices according to a predetermined angle, such as 22.5 degrees. Then, the point set computing module 101 selects points on each of the slices according to a predetermined point number “Num,” such as 25. In one embodiment, a number of the points selected on the first slice is (Num−1)*33.3%, a number of the points selected on the second slice is (Num−1)*16.7%, a number of the points selected on the third slice is (Num−1)*33.3%, a number of the points selected on the fourth slice is (Num−1)*16.7%, and a number of the points selected on the fifth slice is 1.

A coordinate of a center of physical ball 30 is ptCenter=PT−R1. That is, ptCenterx=PTx, ptCentery=PTy, and ptCenterz=PTz−R1. A coordinate of a center of each slice is ptStepnCenter=ptCenter+R1*sin(22.5*(n−1)). For example, a coordinate of a center of the first slice is ptStep1Centerx=ptCenterx, ptStep1Centery=ptCentery, and ptStep1Centerz=ptCenterz. A coordinate of a center of the second slice is ptStep2Centerx=ptCenterx, ptStep2Centery=ptCentery, and ptStep2Centerz=ptCenterz+R1*sin(22.5). A coordinate of a center of the third slice is ptStep3Centerx=ptCenterx, ptStep3Centery=ptCentery, and ptStep3Centerz=ptCenterz+R1*sin(45). A coordinate of a center of the fourth slice is ptStep4Centerx=ptCenterx, ptStep4Centery=ptCentery, and ptStep4Centerz=ptCenterz+R1*sin(67.5). A coordinate of a center of the fifth slice is ptStep5Centerx=ptCenterx, ptStep5Centery=ptCentery, and ptStep5Centerz=ptCenterz+R1*sin(90).

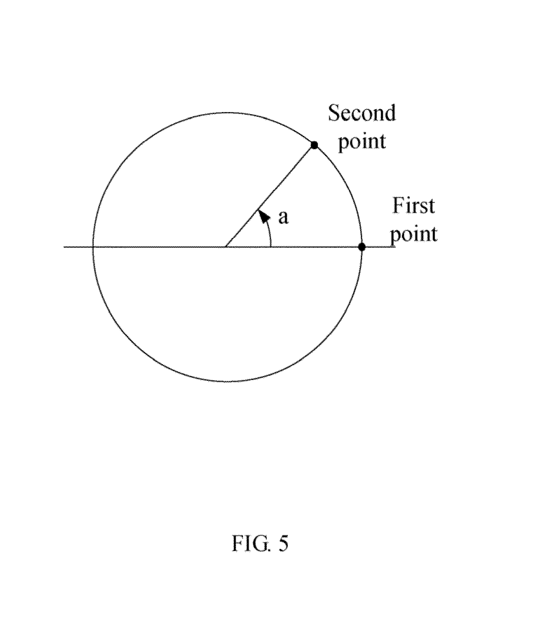

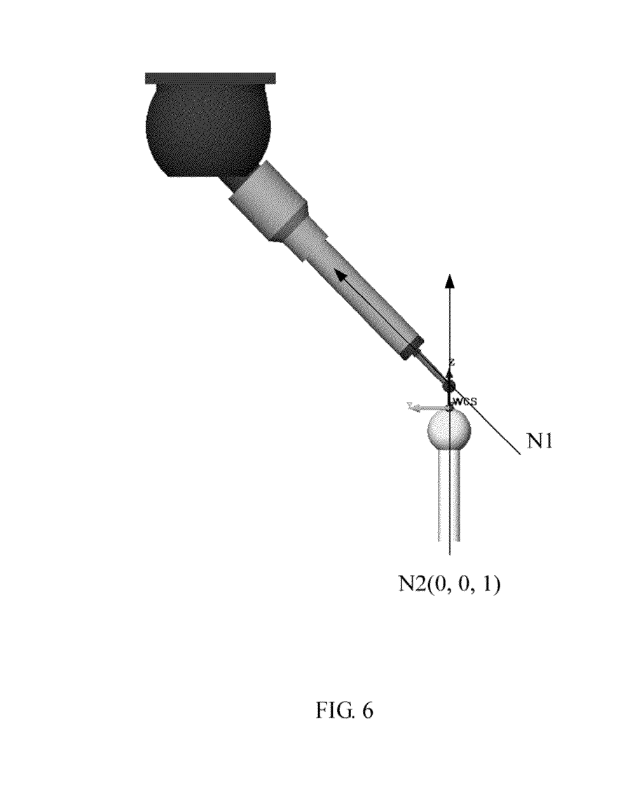

Referring to FIG. 5 and FIG. 6, assuming that an angle between each two of the points selected on one of the slices is “a”, and the vector N2 of the physical ball 30 is (0, 0, 1), a coordinate of the first point selected on this slice is (ptStepnCenterx+R1*cos(22.5(n−1)), ptStepnCentery, ptStepnCenterz), and the coordinate of the nth point selected on this slice is computed by rotating the coordinate (ptStepnCenterx+R1*cos(22.5(n−1)), ptStepnCentery, ptStepnCenterz) to an angle “a*n” round an axis (0, 0, 1). Using the above method, the point set computing module 101 computes the coordinates of the points selected on each of the slices. The vectors of all the points selected on each slice point to the center of the physical ball 30.

In step S302, the rotating module 102 computes a rotating vector N3 by cross-multiplying the vector N1 and the vector N2, and generates a rotating matrix by rotating the physical ball 30 with a predetermined angle round the rotating vector N3. In one embodiment, the predetermined angle is equal to an angle between the vector N1 and the vector N2.

In step S303, the point set updating module 103 updates the coordinates in the reference point set by multiplying the coordinates with the rotating matrix to update the reference point set.

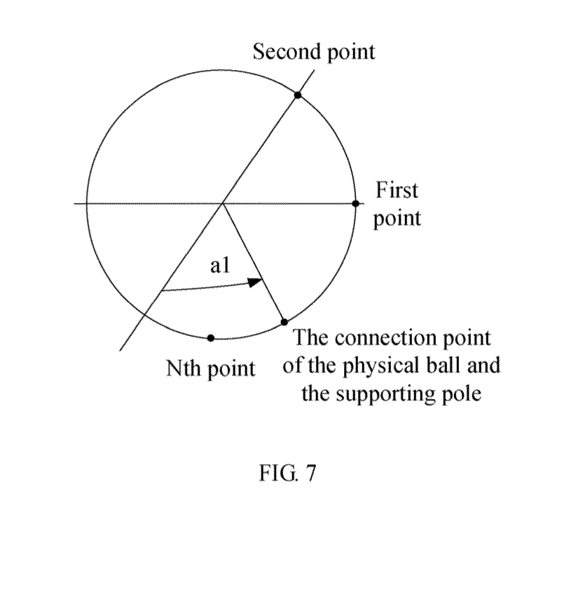

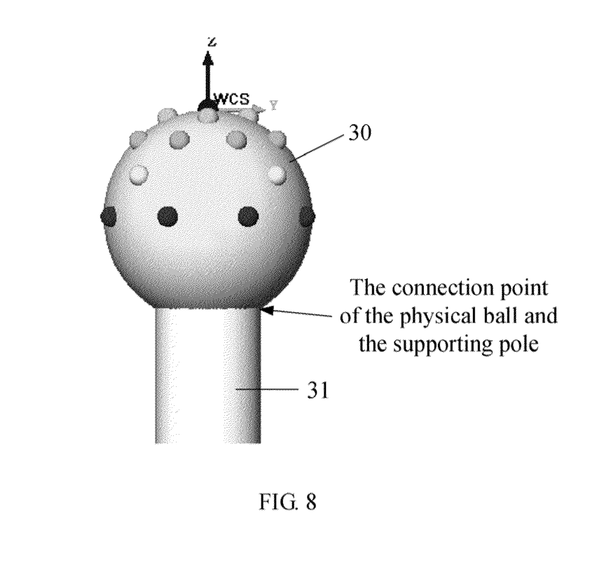

In step S304, the point set updating module 103 compares a coordinate of a connection point of the physical ball 30 and the supporting pole 31 with each of the coordinates in the reference point set, and updates the reference point set until all Z-coordinates in the reference point set are less than a Z-coordinate of the connection point. In one embodiment, the point set updating module 103 computes the coordinates of the nth point in each of the slices in the reference point set by rotating the coordinate of the first point in each slice to an angle “(360−a1)*n” round the axis (0, 0, 1), to update the reference point set. FIG. 7 and FIG. 8 illustrate a connection point of a physical ball and a supporting pole. Referring to FIG. 7, “a1” is an angle between the nth point and the connection point.

In step S305, the measuring module 104 generates a measuring program according to the reference point set, and transmits the measuring program to the measurement machine 2, to measure points on the physical ball 30 two times so as to generate measuring point sets Refs and Meas. In one embodiment, the measuring program is an I++ measuring program illustrated as follows:

### C0001 PtMeas(IJK(−0.00000, −0.00000, 1.00000), X(0.00000), Y(0.00000), Z(0.00000)) C0002

### PtMeas(X(9.23879533),Y(−3.82683432),Z(−12.00000000),IJK(0.92387953, −0.38268343, 0.00000000)) C0003

### PtMeas(X(3.82683432),Y(−9.23879533),Z(−12.00000000),IJK(0.38268343, −0.92387953, 0.00000000)).

In step S306, the compensating module 105 computes compensation values of the probe 20 according to the measuring point sets (denoted as Refs and Meas), the radius R1 of the physical ball 30, and the radius R2 of the head part 21, and further computes a measurement error of the probe 20 according to the measuring point sets Refs and Meas. In one embodiment, the compensation values include a radius compensation value and a center compensation value of the head part 21 of the probe 20.

In one embodiment, the compensating module 105 fits a first reference ball using the measuring point set Refs, and obtains a center ptRef and a radius rRef of the first reference ball. The compensating module 105 further fits a second reference ball using the measuring point set Meas, and obtains a center ptMeas and a radius rMeas of the second reference ball. The compensating module 105 computes the radius compensation value using the formula: rOffset=rMeas−R1+R2. Furthermore, the compensating module 105 computes the center compensation value using the formula: ptOffest=ptMeas+ptNorminal−ptRef, where “ptNorminal” is a standard length of the measuring pole 22.

In one embodiment, the compensating module 105 computes the measurement error using the formula: SpaceError=maxR−minR, where maxR is a maxmum distance between the points in the measuring point set Meas and the center of the second reference ball, and minR is a minimum distance measuring point set Meas and the center of the second reference ball.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method of compensating precision of measurements using a probe of a three dimensional (3D) measurement machine, the method being performed by execution of computerized codes by a processor of a computing device, the method comprising:
providing a physical ball which rests on a supporting pole;
loading data from a storage device of the computing device, wherein the data includes a radius R1 of the physical ball, a radius R2 of a head part of the probe, a coordinate PT of a point located on the top of the physical ball, a vector N1 of a measuring pole of the probe, and a vector N2 of the physical ball;
dividing surfaces of the physical ball into a plurality of horizontal slices, selecting points on each of the slices, and computing coordinates and vectors of the points according to the radius R1, the coordinate PT, and the vector N2 of the physical ball to generate a reference point set;
computing a rotating vector N3 by cross-multiplying the vector N1 and the vector N2, and generating a rotating matrix by rotating the physical ball with a predetermined angle round the rotating vector N3;
updating the coordinates in the reference point set by multiplying the coordinates with the rotating matrix to update the reference point set;
generating a measuring program according to the reference point set, and transmitting the measuring program to the 3D measurement machine to measure points on the physical ball two times to generate two measuring point sets that are denoted as Refs and Meas; and
computing compensation values of the probe according to the measuring point sets Refs and Meas, the radius R1 of the physical ball, and the radius R2 of the head part, and computing a measurement error of the probe according to the measuring point sets Refs and Meas.

2. The method according to claim 1, wherein the predetermined angle is equal to an angle between the vector N1 and the vector N2.

3. The method according to claim 1, wherein the updating step further comprises:
comparing a coordinate of a connection point of the physical ball and the supporting pole with each of the coordinates in the reference point set, and updating the reference point set until all Z-coordinates in the reference point set are less than a Z-coordinate of the connection point.

4. The method according to claim 1, wherein the compensation values comprise a radius compensation value and a center compensation value of the head part of the probe.

5. The method according to claim 4, wherein the step of computing compensation values comprises:
fitting a first reference ball using the measuring point set Refs, obtaining a center ptRef and a radius rRef of the first reference ball;
fitting a second reference ball using the measuring point set Meas, obtaining a center ptMeas and a radius rMeas of the second reference ball;
computing the radius compensation value using a formula: rOffset=rMeas−R1+R2, and computing the center compensation value using a formula: ptOffest=ptMeas+ptNorminal−ptRef, wherein “ptNorminal” is a standard length of the measuring pole.

6. The method according to claim 1, wherein the measurement error is computed using a formula: SpaceError=maxR−minR, wherein maxR is a maxmum distance between the points in the measuring point set Meas and the center of the second reference ball, and minR is a minimum distance measuring point set Meas and the center of the second reference ball.

7. A computing device, comprising:
a storage device;
at least one processor; and
one or more modules that are stored in the storage device and executed by the at least one processor, the one or more modules comprising instructions to:
load data from the storage device, wherein the data includes a radius R1 of a physical ball, a radius R2 of a head part of a probe of a three dimensional (3D) measurement machine, a coordinate PT of a point located on the top of the physical ball, a vector N1 of a measuring pole of the probe, and a vector N2 of the physical ball;
divide surfaces of the physical ball into a plurality of slices, select points on each of the slices, and compute coordinates and vectors of the points according to the radius R1, the coordinate PT, and the vector N2 of the physical ball to generate a reference point set;
compute a rotating vector N3 by cross-multiplying the vector N1 and the vector N2, and generate a rotating matrix by rotating the physical ball a predetermined angle round the rotating vector N3;
update the coordinates in the reference point set by multiplying the coordinates with the rotating matrix to update the reference point set;
generate a measuring program according to the reference point set, and transmit the measuring program to the 3D measurement machine to measure points on the physical ball two times to generate two measuring point sets that are denoted as Refs and Meas; and
compute compensation values of the probe according to the measuring point sets Refs and Meas, the radius R1 of the physical ball, and the radius R2 of the head part, and further compute a measurement error of the probe according to the measuring point sets Refs and Meas.

8. The computing device according to claim 7, wherein the predetermined angle is equal to an angle between the vector N1 and the vector N2.

9. The computing device according to claim 8, wherein the one or more modules further comprises instructions to:
compare a coordinate of a connection point of the physical ball and the supporting pole with each of the coordinates in the reference point set, and update the reference point set until all Z-coordinates in the reference point set are less than a Z-coordinate of the connection point.

10. The computing device according to claim 7, wherein the compensation values comprise a radius compensation value and a center compensation value of the head part of the probe.

11. The computing device according to claim 10, wherein the one or more modules further comprises instructions to:
fit a first reference ball using the measuring point set Refs, obtain a center ptRef and a radius rRef of the first reference ball;
fit a second reference ball using the measuring point set Meas, obtain a center ptMeas and a radius rMeas of the second reference ball; and
compute the radius compensation value using a formula: rOffset=rMeas−R1+R2, and compute the center compensation value using a formula: ptOffest=ptMeas+ptNorminal−ptRef, wherein “ptNorminal” is a standard length of the measuring pole.

12. The computing device according to claim 7, wherein the measurement error is computed using a formula: SpaceError=maxR−minR, wherein maxR is a maxmum distance between the points in the measuring point set Meas and the center of the second reference ball, and minR is a minimum distance measuring point set Meas and the center of the second reference ball.

13. A non-transitory storage medium having stored thereon instructions that, when executed by a processor of an computing device, causes the processor to perform a method of compensating precision of measurements using a probe of a three dimensional (3D) measurement machine, wherein the method comprises:
loading data from a storage device of the computing device, wherein the data includes a radius R1 of a physical ball, a radius R2 of a head part of the probe, a coordinate PT of a point located on the top of the physical ball, a vector N1 of a measuring pole of the probe, and a vector N2 of the physical ball;
dividing surfaces of the physical ball into a plurality of horizontal slices, selecting points on each of the slices, and computing coordinates and vectors of the points according to the radius R1, the coordinate PT, and the vector N2 of the physical ball to generate a reference point set;
computing a rotating vector N3 by cross-multiplying the vector N1 and the vector N2, and generating a rotating matrix by rotating the physical ball a predetermined angle round the rotating vector N3;
updating the coordinates in the reference point set by multiplying the coordinates with the rotating matrix to update the reference point set;
generating a measuring program according to the reference point set, and transmitting the measuring program to the 3D measurement machine to measure points on the physical ball two times to generate two measuring point sets that are denoted as Refs and Meas; and
computing compensation values of the probe according to the measuring point sets Refs and Meas, the radius R1 of the physical ball, and the radius R2 of the head part, and further computing a measurement error of the probe according to the measuring point sets Refs and Meas.

14. The non-transitory storage medium according to claim 13, wherein the predetermined angle is equal to an angle between the vector N1 and the vector N2.

15. The non-transitory storage medium according to claim 13, wherein the updating step further comprises:
comparing a coordinate of a connection point of the physical ball and the supporting pole with each of the coordinates in the reference point set, and updating the reference point set until all Z-coordinates in the reference point set are less than a Z-coordinate of the connection point.

16. The non-transitory storage medium according to claim 13, wherein the compensation values comprise a radius compensation value and a center compensation value of the head part of the probe.

17. The non-transitory storage medium according to claim 16, wherein the step of computing compensation values comprises:
fitting a first reference ball using the measuring point set Refs, obtaining a center ptRef and a radius rRef of the first reference ball;
fitting a second reference ball using the measuring point set Meas, obtaining a center ptMeas and a radius rMeas of the second reference ball;
computing the radius compensation value using a formula: rOffset=rMeas−R1+R2, and computing the center compensation value using a formulas: ptOffest=ptMeas+ptNorminal−ptRef, wherein “ptNorminal” is a standard length of the measuring pole.

18. The non-transitory storage medium according to claim 13, wherein the measurement error is computed using a formula: SpaceError=maxR−minR, wherein maxR is a maxmum distance between the points in the measuring point set Meas and the center of the second reference ball, and minR is a minimum distance measuring point set Meas and the center of the second reference ball.
